(19) United States
(12) Patent Application Publication
(10) Pub. No.: US 2008/0135179 A1
(43) Pub. Date: Jun. 12, 2008

(54) Tape gun and cutting blade

(76) Inventor: Noel Bedard, St-Augustin (CA)

Correspondence Address: Noel Bedard, 109 rue d, Amsterdam, St-Augustin-de-Desmaures, QC, G3A 2V5, omitted

(21) Appl. No.: 11/636,346

(22) Filed: Dec. 11, 2006

(51) Int. Cl. B29C 65/50

(52) U.S. Cl. 156/510

(57) ABSTRACT

A tape gun for adhesive tape which is provided with cutting blade to facilitate the sealing of the boxes.

### BACKGROUND OF THE INVENTION

1. Field of the Invention

The present invention relates to a tape gun, and more particularly to a tape gun for adhesive tape which is provided with cutting blade to facilitate the sealing of the boxes.

2. Description of the Related Art

A search of prior art records has unveiled the following patents:

### 1. CA 1,259,283 registered in 1989 to Smidt;

### 2. CA 2,130,312 registered in 1994 to Lafond;

### 3. CA 2,193,188 registered in 1996 to Huang;

4. U.S. Pat. No. 6,478,067 issued in 2002 to Huang;
5. U.S. Pat. No. 7,140,165 issued in 2006 to Ventura; and
6. U.S. Pat. No. 6,923,358 issued in 2005 to Chandaria.

### SUMMARY OF THE INVENTION

In accordance with the teachings of the present invention, there is disclosed a tape gun for adhesive tape with cutting blade to facilitate the sealing of the boxes.

### BRIEF DESCRIPTION OF THE DRAWINGS

FIGS. 1a and 1b are perspective view showing the functioning of the tape gun.

FIG. 2a is a side view of FIG. 1a.

FIG. 2b is a side view of FIG. 1b.

FIG. 3a is a plan view of FIG. 1a.

FIG. 3b is a plan view of FIG. 1b.

FIG. 4a is an elevational view of FIG. 1a.

FIG. 4b is an elevational view of FIG. 1b.

FIG. 5 is an exploded view of the tape gun with cutter in position for assembly.

### DETAILED DESCRIPTION OF THE INVENTION

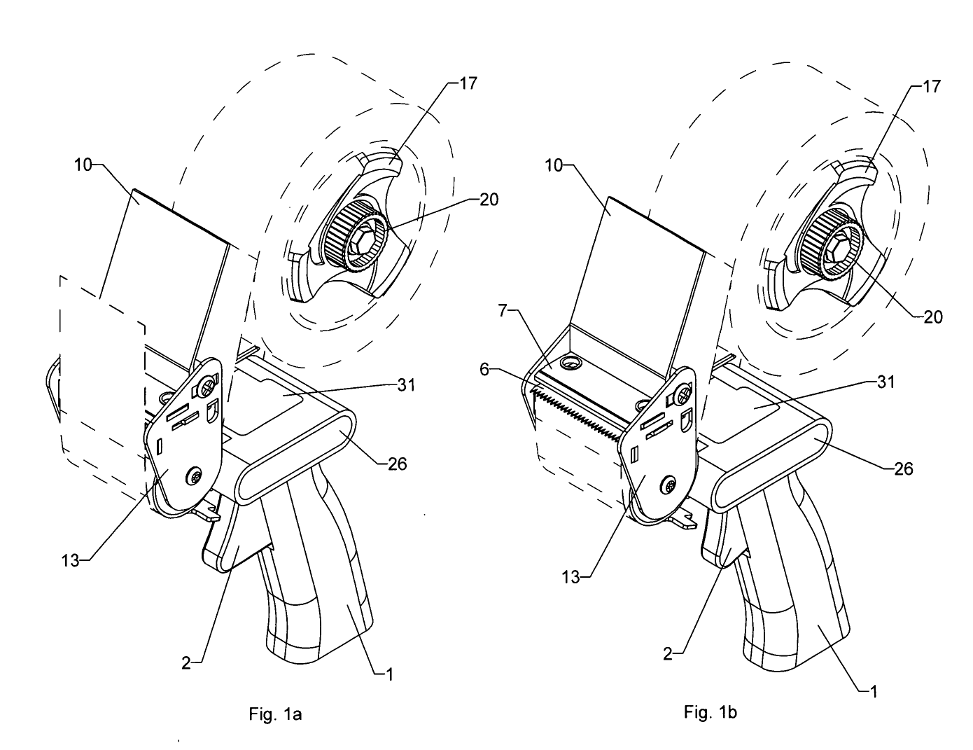

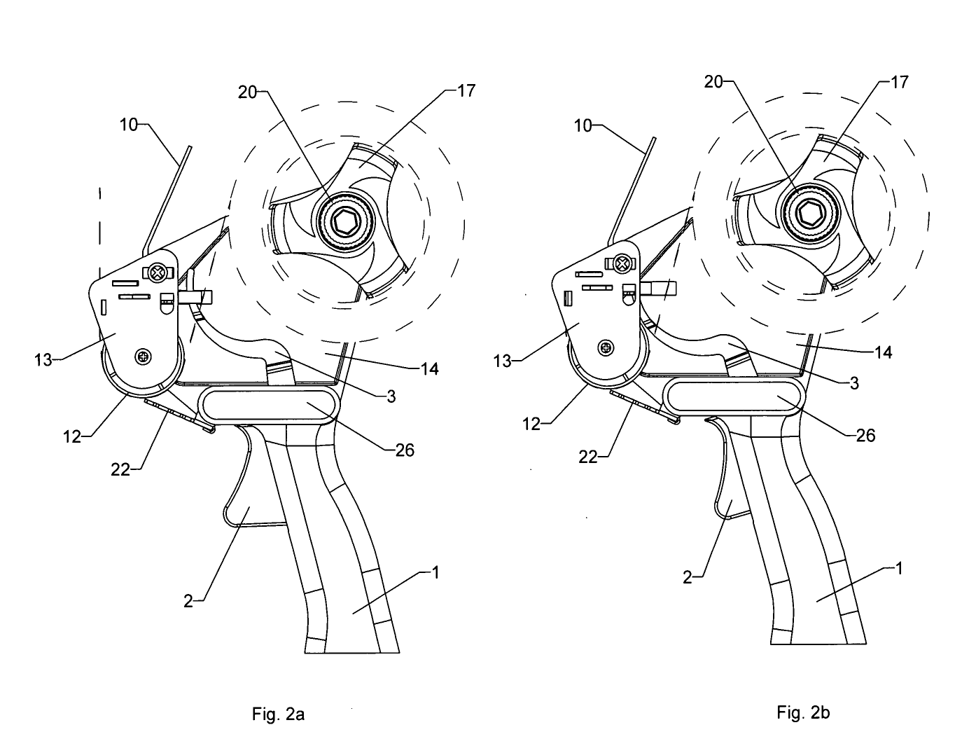

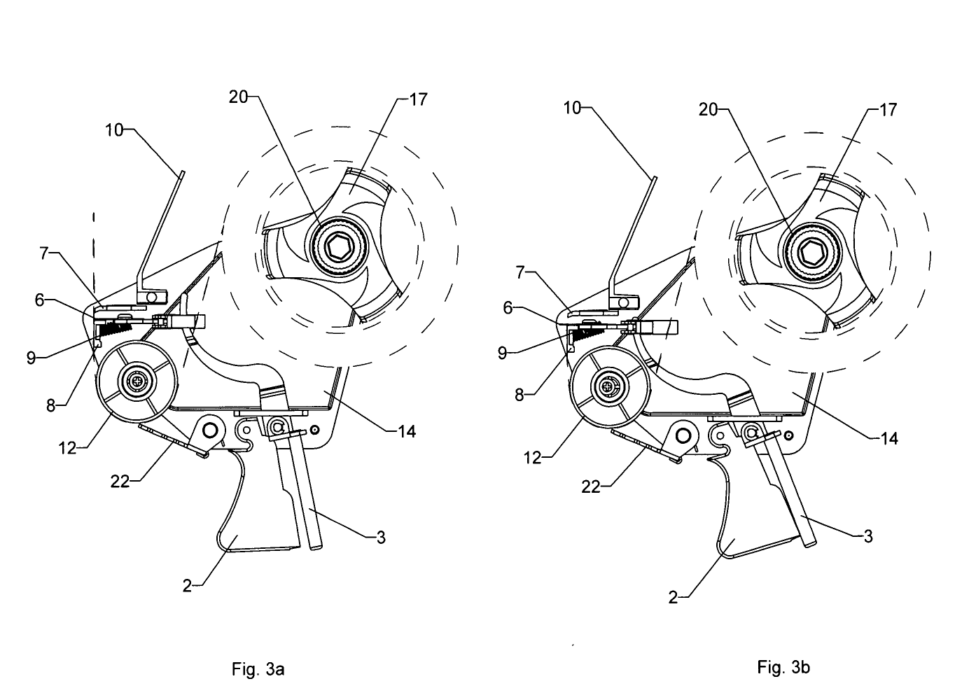

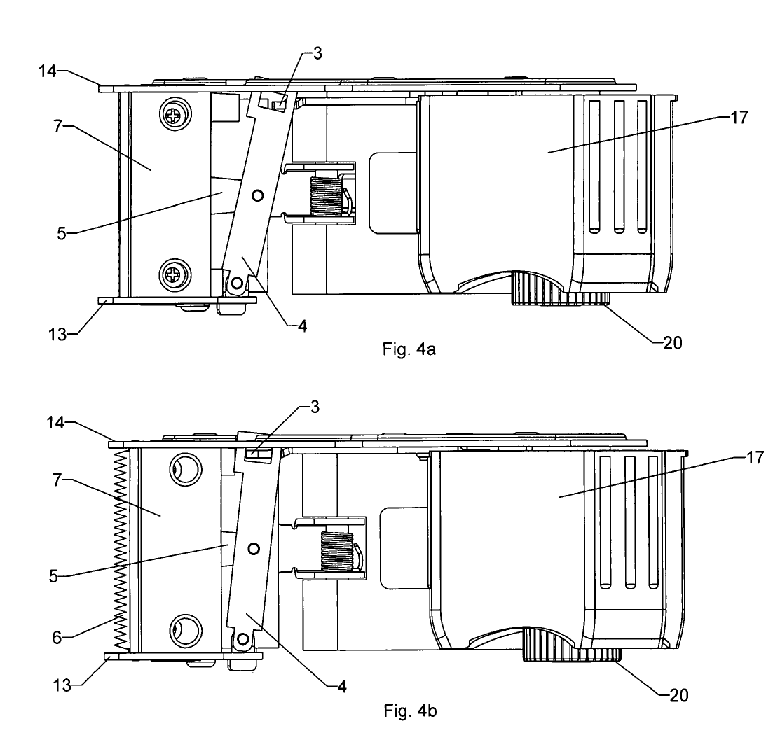

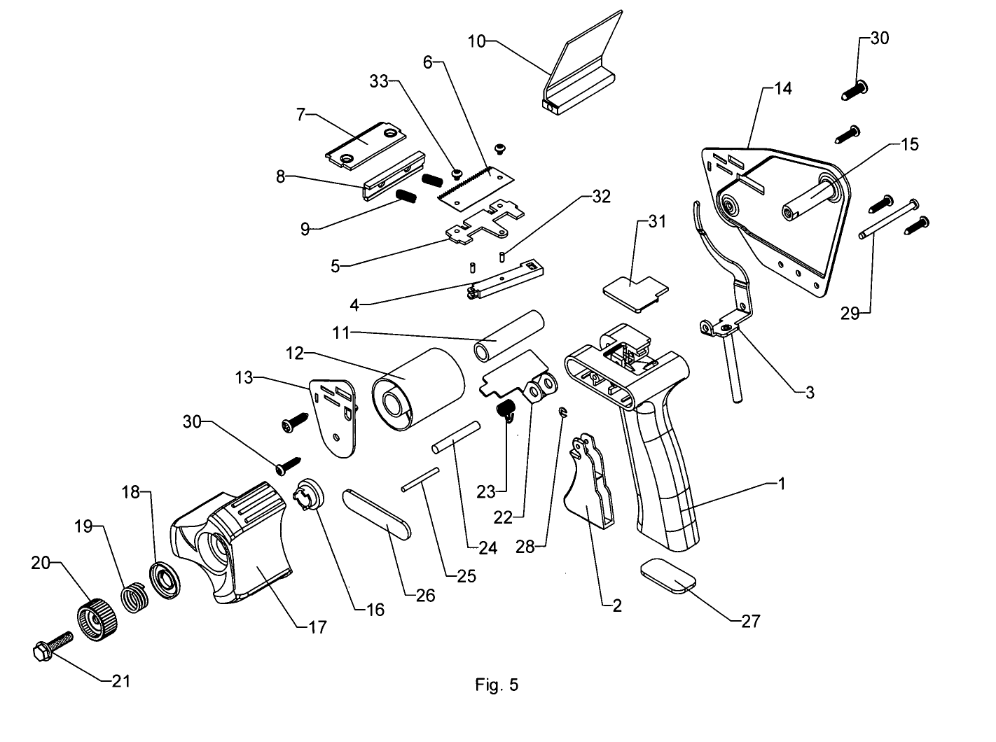

As shown in FIGS. 1 to 5, a tape gun of the preferred embodiment of the present invention comprising a handle provided with a trigger (2) and fixed to a side plate (14); a rotary part (17) fixed to the side plate (14) for mounting an adhesive tape roller; a roller (12) pivotally mounted between the side plate (14) and a side plate (13); a cutting blade arranged between the both side plates (13)(14), two arm levers (3)(4), a support blade (5), and two springs (9).

When an external force is exerted on the trigger (2) a first arm lever (3) engages a second arm lever (4) to move the support blade (5) such that the support blade (5) guides the cutting blade outwards to intercept the adhesive tape for it cutting, and when the trigger (2) is released the both springs (9) bring back the cutting blade inwards. Although only a single embodiment of the present invention has been described and illustrated, the present invention is not limited to the features of this embodiment, but includes all variations and modifications within the scope of claims.

The embodiments of the invention for which an exclusive property or privilege is claimed, are defined as follows:

1. A tape gun for adhesive tape comprising:
a handle provided with a trigger,
a cutting blade,
two arm levers,
a support blade,
two springs,
wherein a first arm lever engages a second arm lever when an external force is exerted on the trigger to move the support blade such that said support blade guides the cutting blade outwards to intercept the adhesive tape for it cutting, and when said trigger is released the both springs bring back the cutting blade inwards.
